(19) United States
(12) Patent Application Publication
(10) Pub. No.: US 2010/0195201 A1
(43) Pub. Date: Aug. 5, 2010

(54) SCREEN

(76) Inventors: Kiyoshi Minoura, Osaka (JP); Eiji Satoh, Osaka (JP); Yasushi Asaoka, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/678,824

(22) PCT Filed: Jul. 29, 2008
(86) PCT No.: PCT/JP2008/002016

§ 371 Date: Mar. 18, 2010

(30) Foreign Application Priority Data
Sep. 25, 2007 (JP) 2007-247948

(51) Int. Cl. G03B 21/60

(52) U.S. Cl. 359/452; 359/459

(57) ABSTRACT

A screen according to the present invention includes: a retroreflective layer, which has a front side and a rear side with an array of corner cubes; a low-refractive-index layer, which is made of a substance with a lower refractive index than the retroreflective layer; and a light absorbing layer for absorbing at least a part of the light that has been incident on the retroreflective layer on the front side thereof and then directed toward the low-refractive-index layer through the rear side thereof. In one embodiment, at least a portion of the light absorbing layer faces the array of corner cubes of the retroreflective layer with the low-refractive-index layer interposed between itself and the retroreflective layer.

### TECHNICAL FIELD

The present invention relates to a screen for use with a projector.

### BACKGROUND ART

A projection system can display a huge image on a screen using a projector (i.e., an image projector) of a small size, and therefore, is now used extensively for a movie viewing in a movie theater or a home theater and for a conference presentation.

A projector projects light with high intensity in a bright display mode but projects light with low intensity in a dark display mode. A front projection system, which can be used more easily in a narrow space than a rear one, generally uses a screen that reflects incident light diffusively. If the screen reflects diffusively the light that has been projected by a projector, a lot of viewers can view the image produced. However, such a diffuse-reflecting screen will diffusively reflect not just the projected light but also ambient light as well. That is why if the environment surrounding the screen is bright, then the screen will look unnecessarily bright irrespective of what should be displayed by the projector. Such a screen can be used only in a relatively dark environment and cannot present a viewable image in a bright environment.

Thus, to overcome such a problem, screens that will retro-reflect incident light have been researched and developed. Such a screen will reflect most of the light projected by the projector back to the vicinity of the projector and will also reflect the ambient light on its way back, not toward the viewer. That is why if a projector is arranged near the viewer, such a screen will reflect the light projected by the projector toward the viewer efficiently, and will look reasonably bright in a bright display mode. In addition, as such a screen will reflect the ambient light away from the viewer, the screen will look darker in a dark display mode than a normal diffuse-reflecting screen. In this manner, by using such a screen that will retro-reflect incident light, the contrast ratio can be increased.

FIG. 28 is a schematic cross-sectional view of a screen 600 as disclosed in Patent Document No. 1. The screen 600 is a bead type screen.

The screen 600 includes a base member 602, an adhesive layer 604 supported on the base member 602, beads 610 bonded with the adhesive layer 604, and a light absorbing material 630, which is arranged closer to the viewer than the beads 610 are. As shown in FIG. 29, each of those beads 610 is designed so that its upper half portion functions as a lens and that the incident light is focused on a plane in its lower half portion. And those beads 610 retro-reflect the incident light. Meanwhile, the light absorbing material 630 that is arranged closer to the viewer than the beads 610 are absorbs the ambient light, thus preventing the image from getting blurred or from having a decreased contrast ratio.

FIG. 30 is a schematic representation of a screen 700 as disclosed in Patent Document No. 2. The screen 700 is also a bead type screen.

The screen 700 includes a substrate 702, beads 710, a cholesteric liquid crystal layer 715, and first and second opaque layers 730 and 735. The cholesteric liquid crystal layer 715 has circular polarization selectivity and selectively reflects circularly polarized light with a particular polarization direction. A projector for use with this screen 700 projects such circularly polarized light with the particular polarization direction. That is why the projected light is reflected by the cholesteric liquid crystal layer 715 and part of the ambient light is transmitted through the cholesteric liquid crystal layer 715. That ambient light that has been transmitted through the cholesteric liquid crystal layer 715 is then absorbed into the first opaque layer 730. Meanwhile, another part of the ambient light that has been incident on the screen 700 with a large polar angle is absorbed into the second opaque layer 735 because the second opaque layer 735 is thick enough in its traveling direction. As used herein, the “polar angle” refers to the angle defined with respect to the optical axis of the projector that crosses the screen at right angles. In this manner, the screen 700 not only absorbs the ambient light to prevent that light from being reflected toward the viewer but also selectively reflects only the light that has been projected by the projector, thereby increasing the contrast ratio.

As screens that retro-reflect incident light, a corner cube type screen (see Patent Document No. 3, for example), as well as the bead-type screens shown in FIGS. 28 to 30, is also known.

Patent Document No. 3 discloses a corner cube type screen. Specifically, in Patent Document No. 3, each corner cube is defined by three metallic planes that are opposed perpendicularly to each other.

FIG. 31 is a schematic representation illustrating a corner cube type screen. A cubic corner cube is defined by three square faces of the corner cube that are defined as yz, xz and xy planes, respectively, and that are opposed perpendicularly to each other. Those three faces of each corner cube that are defined as yz, xz and xy planes will be referred to herein as first, second and third faces and the traveling direction of the incident light will be defined by a vector (a, b, c). In that case, first of all, the incident light is reflected by the first face, has its traveling directions changed into a one represented by a vector (−a, b, c) and then goes toward the second face. Then, that reflected light is reflected again by the second face, has its traveling directions changed into a one represented by a vector (−a, −b, c) and then goes toward the third face. And that reflected light is once again reflected by the third face and eventually has its traveling directions changed into a one represented by a vector (−a, −b, −c). In this manner, the incident light is sequentially reflected by those three faces of the corner cube that are opposed perpendicularly to each other and is eventually retro-reflected. An array of corner cubes in an ideal shape could retro-reflect incident light with a zero polar angle perfectly, theoretically speaking. Actually, however, it is difficult to make an array of corner cubes with a small pitch (of 100 μm or less) in an ideal shape. In this description, a surface that will retro-reflect incident light will be referred to herein as a “retroreflective surface”.
Patent Document No. 1: Japanese Patent Application Laid-Open Publication No. 8-152684
Patent Document No. 2: Japanese Patent Application Laid-Open Publication No. 2003-287818
Patent Document No. 3: Japanese Patent Application Laid-Open Publication No. 5-150368

### DISCLOSURE OF INVENTION

### Problems to be Solved by the Invention

The screen of Patent Document No. 1 has the light absorbing material that is arranged closer to the viewer than its retroreflective surface is. That is why even if the entire incident light had a zero polar angle, the aperture ratio would still decrease due to the presence of that light absorbing material. On top of that, as projected light actually includes components with non-zero polar angles, the light absorbing material will partially absorb those components, too. As a result, the brightness on the screen should not be enough.

In addition, since aberration would be produced by those beads as retroreflector, the screens of Patent Document Nos. 1 and 2 cannot have sufficiently high retroreflectivity. On top of that, as the beads are spheres, the surface cannot be filled with those beads completely, and therefore, sufficiently high retroreflectivity cannot be achieved.

Meanwhile, generally speaking, a corner cube type screen will achieve a higher retroreflectivity than a bead type screen. However, even if such a screen is used, a sufficiently high contrast ratio still cannot be achieved unless the intensity of the light projected by the project or is rather high in a bright display mode. For that reason, such corner cube type screen can find only limited applications.

It is therefore an object of the present invention to provide a screen that can be used effectively to present an image with a high contrast ratio.

### Means for Solving the Problems

A screen according to the present invention includes: a retroreflective layer, which has a front side and a rear side and which includes an array of corner cubes on the rear side; a low-refractive-index layer, which is made of a substance with a lower refractive index than the retroreflective layer and which is in contact with at least a portion of the array of corner cubes of the retroreflective layer; and a light absorbing layer for absorbing at least a part of the light that has been incident on the retroreflective layer on the front side thereof and then directed toward the low-refractive-index layer through the rear side thereof.

In one embodiment, at least a portion of the light absorbing layer faces the array of corner cubes of the retroreflective layer with the low-refractive-index layer interposed between itself and the retroreflective layer.

In one embodiment, the low-refractive-index layer is an air layer.

In one embodiment, the screen further includes a light scattering member for scattering a part of the light that has been incident on the retroreflective layer on the front side thereof and then retro-reflected from an interface between the rear side of the retroreflective layer and the low-refractive-index layer.

In one embodiment, the light scattering member includes a light scattering layer.

In one embodiment, the light scattering layer has a haze value of less than 50%.

In one embodiment, the light scattering member includes scattering particles that are dispersed in the retroreflective layer.

In one embodiment, the screen further includes a fixing member for fixing the retroreflective layer, the light absorbing layer, and the low-refractive-index layer together so that the retroreflective layer faces the light absorbing layer with the low-refractive-index layer interposed between them.

A projection system according to the present invention includes a screen described above, and a projector with a projection hole for projecting light toward the screen.

In one embodiment, when used, the projector is arranged in substantially the same direction as a viewer who is viewing the screen as viewed from at least some area of the screen.

In one embodiment, when projected onto the screen, a line segment, which connects together the viewer's eye and the projector, has a length of less than 12 cm.

In one embodiment, when used, the projector has its projection hole arranged near the viewer's eye.

In one embodiment, when used, at least one of the projector and the screen is held by the viewer.

In one embodiment, when used, the screen is held by the viewer with his or her hands.

In one embodiment, when used, at least one of the projector and the screen is arranged around the viewer.

### EFFECTS OF THE INVENTION

The present invention provides a screen that can be used effectively to conduct a display operation with a high contrast ratio.

### BRIEF DESCRIPTION OF DRAWINGS

FIG. 1 is a schematic representation illustrating an embodiment of a screen according to the present invention.

FIG. 2 schematically illustrates the screen of this embodiment, wherein FIG. 2(a) is a perspective view, FIG. 2(b) is a plan view, FIG. 2(c) is a cross-sectional view as viewed on the plane A-A′ and FIG. 2(d) is a cross-sectional view as viewed on the plane B—B′ of the screen.

FIG. 3 is a schematic representation illustrating a screen as Comparative Example 2.

FIG. 4 is a schematic representation illustrating a measuring system for evaluating the optical property of a screen.

FIG. 5 is a schematic representation illustrating the optical path of the screen as Comparative Example 2.

FIG. 6 is a schematic representation illustrating the optical path of the screen of this embodiment.

FIG. 7 is a schematic representation illustrating the retro-reflected and non-retro-reflected components of projected light and ambient light that have been produced by the screen.

FIG. 8 is a schematic representation illustrating a screen as Comparative Example 3.

FIG. 9 is a schematic representation illustrating a measuring system for evaluating the optical property of a screen.

FIG. 10 is a graph showing the optical properties of the screen of this embodiment and the screen as Comparative Example 3.

FIG. 11 is a graph showing the optical properties of the screen of this embodiment and the screen as Comparative Example 3.

FIG. 12 is a schematic representation illustrating the optical path of the screen as Comparative Example 3.

FIGS. 13(a) and 13(b) are respectively a perspective view and a plan view schematically illustrating a modified example of the screen of this embodiment.

FIG. 14 is a schematic representation illustrating an embodiment of a projection system according to the present invention.

FIG. 15 is a schematic representation illustrating a modified example of the projection system of this embodiment.

FIGS. 16(a) and 16(b) are schematic representations illustrating two arrangements of a projector in the projection system of this embodiment.

FIGS. 17(a) and 17(b) are schematic representations illustrating another modified example of the projection system of this embodiment.

FIG. 18 is a schematic representation illustrating still another modified example of the projection system of this embodiment.

FIG. 19 is a schematic representation illustrating how the projection system shown in FIG. 18 may be used.

FIG. 20(a) is a schematic representation illustrating yet another modified example of the projection system of this embodiment and FIG. 20(b) is a schematic representation illustrating the screen of that projection system.

FIG. 21 is a schematic representation illustrating yet another modified example of the projection system of this embodiment.

FIG. 22(a) is a schematic representation illustrating yet another modified example of the projection system of this embodiment and FIG. 22(b) is a schematic representation illustrating the screen of that projection system.

FIGS. 23(a) and 23(b) are schematic representations illustrating yet another modified example of the projection system of this embodiment.

FIG. 24 is a schematic representation illustrating yet another modified example of the projection system of this embodiment.

FIG. 25 is a schematic representation illustrating yet another modified example of the projection system of this embodiment.

FIG. 26 is a schematic representation illustrating yet another modified example of the projection system of this embodiment.

FIGS. 27(a) and 27(b) are respectively a schematic front view and a schematic side view illustrating yet another modified example of the projection system of this embodiment.

FIG. 28 is a schematic representation illustrating a screen as disclosed in Patent Document No. 1.

FIG. 29 is a schematic representation illustrating how light is retro-reflected by a bead.

FIG. 30 is a schematic representation illustrating a screen as disclosed in Patent Document No. 2.

FIG. 31 is a schematic representation illustrating how light is retro-reflected by a corner cube.

### DESCRIPTION OF REFERENCE NUMERALS

100 screen
102 base member
110 retroreflective layer
120 low-refractive-index layer
130 light absorbing layer
140 light scattering layer

### BEST MODE FOR CARRYING OUT THE INVENTION

Hereinafter, embodiments of the present invention will be described with reference to the accompanying drawings. It should be noted that the present invention is in no way limited to the specific embodiments to be described below.

### Embodiment 1

First of all, an Embodiment of a Screen According to the present invention will be described.

FIG. 1 is a schematic representation illustrating a screen 100 of this embodiment. The screen 100 includes a retroreflective layer 110, a low-refractive-index layer 120, and a light absorbing layer 130. The screen 100 further includes a base member 102 that supports the retroreflective layer 110, a light scattering member 140 and a fixing member 145. The screen 100 may be as large as an A4 sheet of paper.

Although not shown in FIG. 1, a projector for projecting an image onto this screen 100 is a front projection type projector that projects light onto the front surface of the screen 100 (i.e., the surface that is located closer to the viewer). The light that has been emitted from the projector will travel along the optical axis of the projector but will also pass the vicinity thereof. As viewed from the screen 100, the projector and the viewer are arranged in substantially the same direction. For example, the projector may be arranged on the viewer him- or herself.

The retroreflective layer 110 may have a flat front side 112 and a rear side 114 with an array of corner cubes. The retroreflective layer 110 is made of a transparent material. For example, the retroreflective layer 110 may be made of an acrylic resin with a refractive index of approximately 1.53. Also, the retroreflective layer 110 may have a thickness of approximately 30 μm.

The low-refractive-index layer 120 is arranged between the retroreflective layer 110 and the light absorbing layer 130 and is made of a material that has a lower refractive index than the retroreflective layer 110. For example, the low-refractive-index layer 120 may be an air layer with a refractive index of 1.0.

The light absorbing layer 130 is made of a material with low reflectance and absorbs at least a part of the light that has been incident on the front side 112 of the retroreflective layer 110 and then transmitted through its rear side 114 toward the low-refractive-index layer 120. The light absorbing layer 130 may be a sheet of black paper with a reflectance of 2%, for example.

The light absorbing layer 130 is arranged at a predetermined distance from the rear side 114 of the retroreflective layer 110. For example, the distance from the surface of the light absorbing layer 130 to the bottom of the array of corner cubes of the retroreflective layer 110 may be 100 μm or less. In this embodiment, the entire rear side 114 of the retroreflective layer 110 is in contact with the low-refractive-index layer 120 but the retroreflective layer 110 is totally out of contact with the light absorbing layer 130. However, portions of the rear side 114 of the retroreflective layer 110 (e.g., the respective vertices of the corner cubes and their surrounding portions) could be in contact with the light absorbing layer 130.

The base member 102 is made of a transparent material. For example, the base member 102 may be made of polyethylene terephthalate (PET).

In this description, the light scattering member 140 has a layered shape and will also be referred to herein as a “light scattering layer 140” in the following description. For example, an anti-glare/anti-reflection (AGAR) film ReaLook 5301-05 (produced by NOF Corporation) with a haze value of 7% may be used as the light scattering layer 140.

The fixing member 145 holds the light scattering layer 140, the base member 102 and the light absorbing layer 130 together. Also, the fixing member 145 is made of an opaque material and prevents ambient light from being transmitted through the fixing member 145 and entering the rear side of the retroreflective layer 110. A tape may be used as the fixing member 145. It should be noted that the light scattering layer 140, the base member 102 and the retroreflective layer 110 are all transparent and therefore will sometimes be collectively referred to herein as a “transparent member 160”.

As shown in FIG. 1, in this screen 100, the light scattering layer 140, the base member 102, the retroreflective layer 110, the low-refractive-index layer 120 and the light absorbing layer 130 are stacked in this order so that the light scattering layer 140 is located closest to the viewer and that the light absorbing layer 130 is located on the back surface of the screen 100. The light that has been emitted from a projector (not shown in FIG. 1) is transmitted through the light scattering layer 140 and the base member 102 and then incident on the front side 112 of the retroreflective layer 110. Then, the light that has been incident on the retroreflective layer 110 travels from the front side 112 toward the rear side 114 and then collides against the interface between the rear side 114 with the array of corner cubes and the low-refractive-index layer 120. And most of that light is retro-reflected from the array of corner cubes. In the following description, that interface between the rear side 114 of the retroreflective layer 110 and the low-refractive-index layer 120, from which the light is retro-reflected, will sometimes be referred to herein as a “retroreflective surface”. Since the refractive index of the low-refractive-index layer 120 is lower than that of the retroreflective layer 110, light to be incident on the retroreflective surface at an angle of incidence that is greater than a critical angle, in particular, is totally reflected. It should be noted that the bigger the difference in refractive index between the retroreflective layer 110 and the low-refractive-index layer 120, the greater the critical angle and the larger the percentage of the incident light on the retroreflective surface to be totally reflected. Anyway, the light that has been retro-reflected from the retroreflective surface in this manner is transmitted through the retroreflective layer 110, the base member 102 and the light scattering layer 140 in this order on its way back and eventually leaves the screen 100.

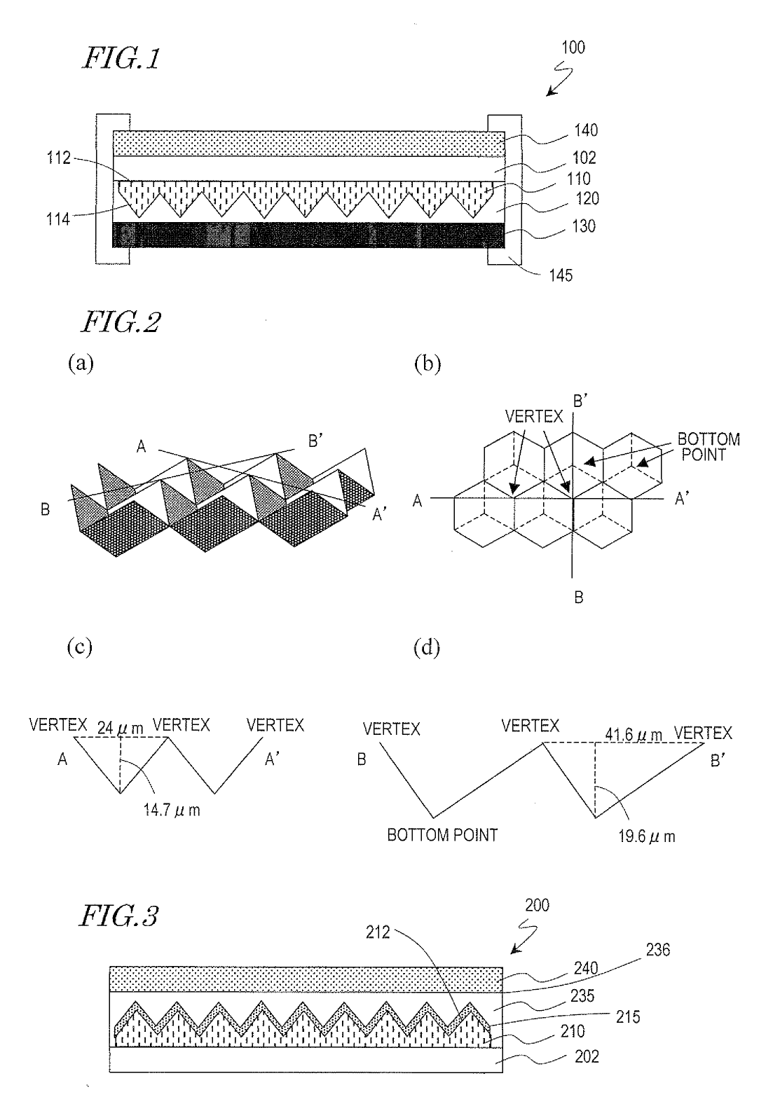

Hereinafter, the array of corner cubes arranged on the rear side 114 of the retroreflective layer 110 will be described with reference to FIG. 2, in which the retroreflective layer 110 is illustrated so that its rear side 114 points upward on the paper.

As shown in FIG. 2(a), each corner cube has a shape corresponding to one corner of a cube and has three square planes that are opposed perpendicularly to each other. Such a corner cube is sometimes called a “cubic corner cube”. Also, on a plan view, the array of corner cubes is an arrangement of regular hexagons as shown in FIG. 2(b). In each of those regular hexagons, its center defines its bottom point (i.e., a depressed portion) and its three corners define its vertices (i.e., raised portions).

FIG. 2(c) is a cross-sectional view as viewed on the plane that passes two adjacent vertices of the array of corner cubes. The distance between those two adjacent vertices is 24 μm, which will be referred to herein as a “pitch” of corner cubes. Also, on this cross-sectional view, the depth as measured from the line segment that connects those two adjacent vertices together (i.e., the distance of the depressed portion as measured from the plane on which the raised portions are located) is 14.7 μm.

FIG. 2(d) is a cross-sectional view as viewed on the plane B-B′ that passes adjacent vertices and bottom points of the array of corner cubes. On this cross-sectional view, the distance between two adjacent vertices is 41.6 μm and the depth of each bottom point as measured from the line segment that connects its associated two adjacent vertices together (i.e., the distance of the depressed portion as measured from the plane on which those raised portions are located) is 19.6 μm. It should be noted that the array of corner cubes is arranged so as to retro-reflect the entire incident light with a polar angle of zero degrees, theoretically speaking.

The screen 100 of this embodiment may be fabricated in the following manner, for example.

First of all, a mold that defines the shape of the array of corner cubes to make is prepared. Such a mold can be obtained by subjecting a GaAs substrate to an etching process as disclosed in Japanese Patent Application Laid-Open Publication No. 2004-086164, the entire contents of which are hereby incorporated by reference.

Next, a base member 102 is prepared. The base member 102 may be made of PET and one principal surface of the base member 102 has been subjected to adhesion facilitating process using MCR-PL-5 produced by Mitsubishi Rayon Co., Ltd. Subsequently, that principal surface of the base member 102 that has been subjected to the adhesion facilitating process is coated with a photosensitive material, which may be a UV curable acrylic material MP107 produced by Mitsubishi Rayon Co., Ltd, for example. Thereafter, the photosensitive material being pressed against the mold is irradiated with an ultraviolet ray and cured, thereby forming an acrylic resin retroreflective layer 110.

Then, the retroreflective layer 110 integral with the base member 102 is removed from the mold. It should be noted that as the base member 102 has been subjected to the adhesion facilitating process, the retroreflective layer 110 integral with the base member 102 can be removed more easily. In this manner, the shape of the mold to make an array of corner cubes is transferred onto the retroreflective layer 110 integral with the base member 102. In this example, the retroreflective layer 110 is formed by 2P (photo polymer) process. However, this is just an example. The retroreflective layer 110 may also be formed by casting process, hot press process or injection molding process. Nevertheless, the 2P process is still preferred to make a thin base member 102 and a thin retroreflective layer 110.

Thereafter, a light scattering layer 140 is bonded onto the front side of the base member 102. The light scattering layer 140 may be an anti-glare/anti-reflection (AGAR) film ReaLook 5301-05 produced by NOF Corporation, for example.

Finally, a light absorbing layer 130 is arranged so as to face at least a portion of the array of corner cubes on the rear side 114 of the retroreflective layer 110 and then fixed with the fixing member 145.

Hereinafter, the optical properties of the screen 100 of this embodiment will be analyzed in comparison with the counterparts of Comparative Examples 1 and 2. First of all, the screens as Comparative Examples 1 and 2 will be described.

The screen of Comparative Example 1 is a diffusive screen that reflects incident light diffusively and may be a sheet of inkjet printing paper on the market.

FIG. 3 is a schematic representation illustrating a screen 200 as Comparative Example 2. The screen 200 includes a base member 202, a retroreflective layer 210 that has a front side 212 with an array of corner cubes, a metal layer 215 that is provided along the array of corner cubes of the retroreflective layer 210, a planarizing layer 235 with a flat front side 236, and a light scattering layer 240, which is arranged on the front side 236 of the planarizing layer 235. Unlike the screen 100 described above, this screen 200 gets the incident light reflected by the metallic material. It should be noted that the light scattering layer 240 and the planarizing layer 235 are both transparent and therefore will sometimes be collectively referred to herein as a “transparent member 260”.

The screen 200 may be fabricated in the following manner, for example.

First of all, a mold that defines the shape of the array of corner cubes to make is prepared. This mold may be the same as what is used to make the screen 100 of the first embodiment of the present invention described above.

Next, a base member 202 is prepared. The base member 202 has had one of its principal surfaces subjected to an adhesion facilitating process using MCR-PL-5 produced by Mitsubishi Rayon Co., Ltd. Subsequently, that principal surface of the base member 202 that has been subjected to the adhesion facilitating process is coated with a photosensitive material, which may be a UV curable acrylic material MP107 produced by Mitsubishi Rayon Co., Ltd, for example. Thereafter, the photosensitive material being pressed against the mold is irradiated with an ultraviolet ray and cured, thereby forming an acrylic resin retroreflective layer 210.

Then, the retroreflective layer 210 integral with the base member 202 is removed from the mold. It should be noted that as the base member 202 has been subjected to the adhesion facilitating process, the retroreflective layer 210 integral with the base member 202 can be removed more easily. An array of corner cubes has been formed on the front side 212 of the retroreflective layer 210.

Subsequently, the front side 212 of the retroreflective layer 210 is covered with a metal layer 215, which may be silver with a thickness of 2,000 Å, for example. The metal layer 215 is provided along the array of corner cubes on the front side 212 of the retroreflective layer 210.

Next, a planarizing layer 235 is deposited over the metal layer 215 to cover the array of corner cubes. The planarizing layer 235 has a flat front side 236.

Thereafter, a light scattering layer 240 is formed onto the front side 236 of the planarizing layer 235. The light scattering layer 140 may be an anti-glare/anti-reflection (AGAR) film ReaLook 5301-05 produced by NOF Corporation, for example. In this example, the AGAR film is adhered to the front side 236 of the planarizing layer 235.

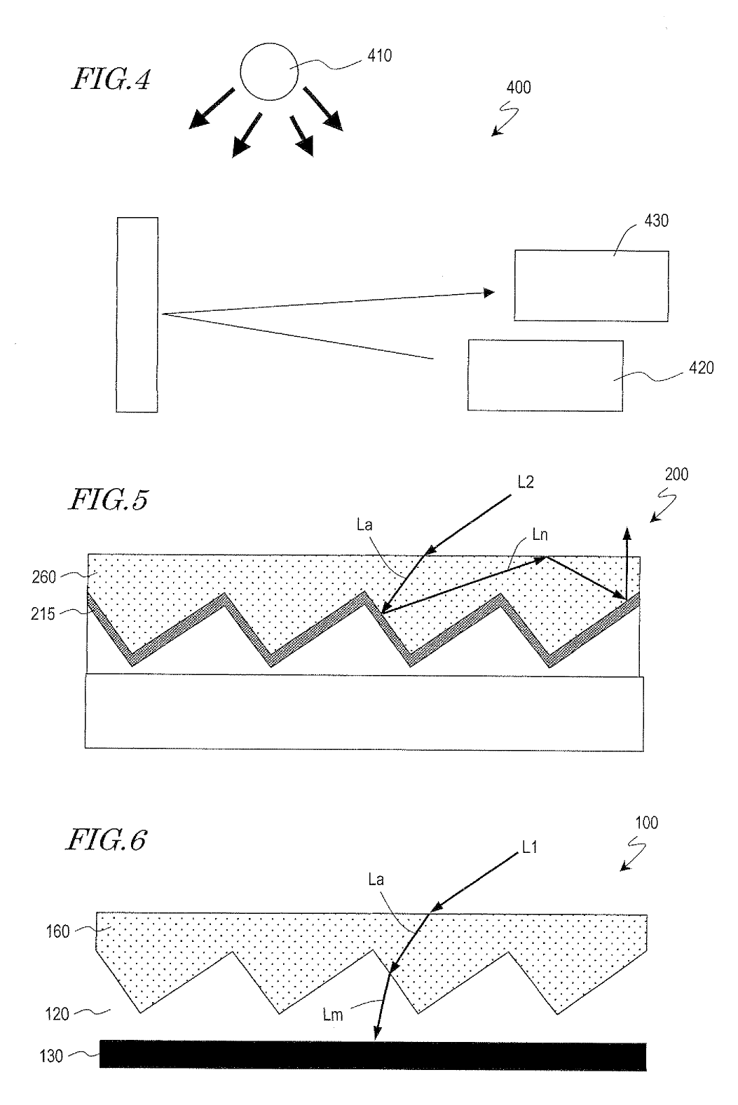

FIG. 4 is a schematic representation illustrating a measuring system 400 for evaluating the optical properties of the screen of this embodiment and the counterparts of Comparative Examples 1 and 2. The measuring system 400 includes a room lamp 410, a small desk fluorescent light 420, and a luminometer 430. The screen of this embodiment and the screens of Comparative Examples 1 and 2 under measurement are arranged under the room lamp 410 with adjustable brightness. The small desk fluorescent light 420 is arranged 40 cm away from the screen and the luminometer 430 is arranged near the small desk fluorescent light 420. The angle defined between the line segment that connects together the small desk fluorescent light 420 and the screen and the line segment that connects together the luminometer 430 and the screen is approximately 10 degrees. In this case, the small desk fluorescent light 420 is used in place of a projector and the brightness on the screen is measured with the luminometer 430.

The following Table 1 summarizes the results of measurements that were obtained by conducting bright and dark display operations under two environments with mutually different ambient illuminances. In this case, the environments were changed between a bright environment (of 3,360 lx) and a dark environment (of 88 lx) by adjusting the room lamp 410, and the modes of display were switched between a bright display mode and a dark display mode by turning ON and OFF the small desk fluorescent light 420.

TABLE 1

| | | Dark | Bright | |
|---|---|---|---|---|
| Environment | Screen | display | display | CR |
| Bright | this | 82 | 2056 | 25 |
| environment | embodiment | | | |
| 3360 lx | Cmp. Ex. 1 | 417 | 604 | 1.5 |
| | Cmp. Ex. 2 | 206 | 1305 | 6.3 |
| Dark | This | 12 | 2008 | 166 |
| environment | embodiment | | | |
| 88 lx | Cmp. Ex. 1 | 15 | 217 | 14 |
| | Cmp. Ex. 2 | 26 | 1149 | 45 |

In Table 1, CR denotes the contrast ratio, i.e., the ratio of the luminance in the bright display mode to the one in the dark display mode. Also, the unit of luminance of cd/m² is omitted from this Table 1.

The contrast ratio of the screen 100 of this embodiment is higher than that of the screen of Comparative Example 1. The reason will be discussed below. In the following description, the light that has come from the fluorescent light 420 to be used in place of a projector will be referred to herein as “projected light” and the light that has come from the room lamp 410 will be referred to herein as “ambient light”.

If the modes of display are changed between the bright and dark display modes under the same environment, the variation in luminance at the screen of Comparative Example 1 is approximately 200, but the luminance variation at the screen 100 of the first embodiment is approximately 2,000. This is probably because although the screen of Comparative Example 1 reflects diffusively the light that has been projected by the fluorescent light 420 and few components of the projected light are reflected toward the luminometer 430, the screen 100 of this embodiment retro-reflects the projected light, and therefore, there are a lot of components of the projected light that are reflected toward the luminometer 430.

On the other hand, if the environments are changed between the bright and dark environments in the same mode of display, the variation in luminance at the screen of Comparative Example 1 is approximately 400, but the luminance variation at the screen 100 of the first embodiment is approximately 60. This is probably because although the screen of Comparative Example 1 also reflects diffusively the ambient light that has been come from the room lamp 410 and a lot of components of the ambient light eventually reach the luminometer 430, the screen 100 of this embodiment retro-reflects the ambient light, too, and therefore, there are few components of the ambient light that reach the luminometer 430.

As can be seen, by using the screen 100, more components of the projected light and less components of the ambient light will eventually reach the viewer. Consequently, the screen 100 has a higher contrast ratio than its counterpart of Comparative Example 1.

In addition, the contrast ratio of the screen 100 of this embodiment is also higher than that of the screen 200 of Comparative Example 2. The reason will be discussed below.

If the modes of display are changed between the bright and dark display modes under the same environment, the variation in luminance at the screen 200 of Comparative Example 2 is approximately 1,100, but the luminance variation at the screen 100 of the first embodiment is approximately 2,000. The screen 200 of Comparative Example 2 also gets the projected light retro-reflected by the array of corner cubes, and therefore, the luminance at the screen 200 of Comparative Example 2 also varies significantly as in the screen of the first embodiment.

Comparing these two types of screens to each other, however, it can be seen that the variation in luminance at the screen 100 of the first embodiment is greater than at the screen 200 of Comparative Example 2. The reason is probably as follows. Specifically, the screen 100 of the first embodiment is supposed to totally reflect every light with a small polar angle (i.e., at a reflectance of 100%), theoretically speaking. On the other hand, the screen 200 of Comparative Example 2 has such light reflected by the metal, which has a reflectance that is slightly lower than 100% (e.g., 95%) each time. As can be seen, there is a relatively small difference in reflectance each time, but the incident light is reflected three times in a retroreflector. That is why supposing the screen 100 of the first embodiment has a retroreflectivity of almost 100% but the metal has a reflectance of 95% each time, for example, the screen 200 eventually has a retroreflectivity of approximately 86%. Consequently, the screen 200 of Comparative Example 2 does not look so bright as the screen 100 of the first embodiment in the bright display mode.

On the other hand, if the environments are changed between the bright and dark environments in the same mode of display, the variation in luminance at the screen 200 of Comparative Example 2 is approximately 180, but the luminance variation at the screen 100 of the first embodiment is approximately 60. The screen 200 of Comparative Example 2 looks particularly bright in the dark display mode under the bright environment, and therefore, has a low contrast ratio under the bright environment.

Hereinafter, it will be described with reference to FIGS. 5 and 6 what are differences between the screen 100 of the first embodiment and the screen 200 of Comparative Example 2. First of all, the optical properties of their corner cubes will be described. As already described with reference to FIG. 31, a corner cube will retro-reflect incident light with a polar angle of zero totally (i.e., at a reflectance of 100), theoretically speaking. However, if a corner cube reflects an incoming light ray with a non-zero polar angle at a point in the vicinity of one of its vertices, then the reflected light ray may go to some direction in which there are no corner cube planes. In that case, the light ray that has been incident on the corner cube is not reflected by all of its three planes, and therefore, not retro-reflected as a result. Such a component of light that has once been incident on a retroreflective plane but is not retro-reflected eventually for some reason will be referred to herein as a “non-retro-reflected component”. Also, in practice, an array of corner cubes cannot be actually formed in its ideal shape. Thus, the bigger the difference between the ideal and actual shapes of an array of corner cubes, the greater the percentage of those non-retro-reflected components. And as those non-retro-reflected components increase, the screen will look even darker in the bright display mode and even brighter in the dark display mode.

In the following description, a component of the incoming light that has been incident on the screen obliquely will be described. It should be noted that ambient light normally includes a relatively great deal of such obliquely incoming light components but that the projected light includes such obliquely incoming light components, too.

As shown in FIG. 5, the obliquely incoming light component gets refracted when entering the transparent member 260 of the screen 200 of Comparative Example 2 and then propagates through the transparent member 260. In FIG. 5, the light L2 is the obliquely incoming light component that has been incident obliquely onto the transparent member 260, and the light La is a component of the light L2 that has been refracted and propagates through the transparent member 260. As the refractive index of the transparent member 260 is greater than that of the air, the angle of refraction (i.e., the polar angle of the light ray La) is smaller than the angle of incidence (i.e., the polar angle of the light ray L2). In a situation where the light ray La has been incident on the retroreflective surface at an acute angle, if the light ray La has a small polar angle, then the angle of incidence defined by the light ray La with respect to the retroreflective surface of the metal layer 215 will be relatively large. The larger the angle of incidence defined by the light ray La with respect to the retroreflective surface, the greater the percentage of the light ray La to be retro-reflected by the retroreflective surface (such components of the light ray will be referred to herein as “retro-reflected components”). Conversely, the larger the polar angle of the light ray La, the smaller the angle of incidence defined by the light ray La with respect to the retroreflective surface and the greater the percentage of non-retro-reflected components. In FIG. 5, the light Ln represents such a non-retro-reflected component.

The light ray Ln propagates through the transparent member 260 at a larger polar angle than when the light ray La was incident on the retroreflective surface. If the polar angle of the light ray Ln is larger than the critical angle at the interface between the transparent member 260 and the air, then the light ray Ln is totally reflected from the interface between the transparent member 260 and the air. After that, the light ray Ln is reflected by another corner cube and then eventually directed toward the viewer.

As described above, such an obliquely incoming light component to be a non-retro-reflected component is included in both projected light and ambient light. That is why strictly speaking, due to the presence of such a non-retro-reflected component, the percentage of the projected light that reaches the viewer decreases and the percentage of the ambient light that reaches the viewer increases. Actually, however, most of those obliquely incoming light components are included in ambient light. Thus, in the screen 200 of Comparative Example 2, the non-retro-reflected components of the ambient light reach the viewer, thereby making the screen 200 look brighter in the dark display mode. For that reason, in Table 1, the luminance on the screen 200 in the dark display mode under the bright environment is relatively high.

On the other hand, in the screen 100 of this embodiment, the obliquely incoming light component gets refracted when entering the transparent member 160 and then propagates through the transparent member 160 as shown in FIG. 6, in which the light L1 is the obliquely incoming light component that has been incident obliquely onto the transparent member 160 and the light La is a component of the light L1 that has been refracted and propagates through the transparent member 160. As already described with reference to FIG. 5, the light ray La has a smaller polar angle than the light ray L1 and propagates through the transparent member 160 toward the retroreflective surface.

As also described with reference to FIG. 5, in a situation where the light ray La has been incident on the retroreflective surface at an acute angle, if the light ray La has a small polar angle, then the angle of incidence defined by the light ray La with respect to the retroreflective surface will be relatively large. The larger the angle of incidence defined by the light ray La with respect to the retroreflective surface, the greater the percentage of the retro-reflected components. Conversely, the larger the polar angle of the light ray La, the smaller the angle of incidence defined by the light ray La with respect to the retroreflective surface and the greater the percentage of non-retro-reflected components.

On top of that, in the screen 100, the light is also retro-reflected from the interface between the retroreflective layer 110 and the low-refractive-index layer 120 as already described with reference to FIG. 1. That is why if the light ray La shown in FIG. 6 is incident on the retroreflective surface at an angle of incidence that is larger than the critical angle, then the light ray La is totally reflected. On the other hand, if the light ray La is incident on the retroreflective surface at an angle of incidence that is smaller than the critical angle, then part of the light ray La is reflected but another part of the light ray La is transmitted through the retroreflective surface. Consequently, in this screen 100, most of the components of the light ray La to be non-retro-reflected components in the screen 200 are transmitted through the retroreflective surface. In FIG. 6, the light Lm is the light ray that has been transmitted through the retroreflective surface. In the screen 100, the light absorbing layer 130 is arranged so as to face the rear side 114 of the retroreflective layer 110. That is why the light ray Lm gets absorbed into the light absorbing layer 130. Consequently, in the screen 100 of this embodiment, the non-retro-reflected components of the ambient light are not reflected but absorbed. As a result, the screen 100 looks dark in the dark display mode. For that reason, in Table 1, the screen 100 has a relatively low luminance in the dark display mode under the bright environment.

As described above, the metal layer 215 of the screen 200 of Comparative Example 2 reflects, toward the front side, not only those components to be retro-reflected but also other components not to be retro-reflected. As a result, a greater percentage of the ambient light will reach the viewer, the screen 200 looks bright in the dark display mode under the bright environment, and a desired high contrast ratio cannot be achieved. On the other hand, in the screen 100 of this embodiment, the interface between the retroreflective layer 110 and the low-refractive-index layer 120 that have mutually different refractive indices retro-reflects those components to be retro-reflected and transmits at least part of the components not to be retro-reflected, which have been produced mainly from the ambient light. After that, the light that has been transmitted through the interface gets absorbed into the light absorbing layer 130. Consequently, the percentage of the ambient light that reaches the viewer can be reduced, the screen 200 looks reasonably dark in the dark display mode under the bright environment, and a desired high contrast ratio can be achieved.

It should be noted that the phenomenon described above cannot explain entirely, but should be one of the major factors of, the difference in optical property between those two types of screens 100 and 200. Also, the reflectance of the metal layer 215 varies rather significantly according to the type of its underlying film.

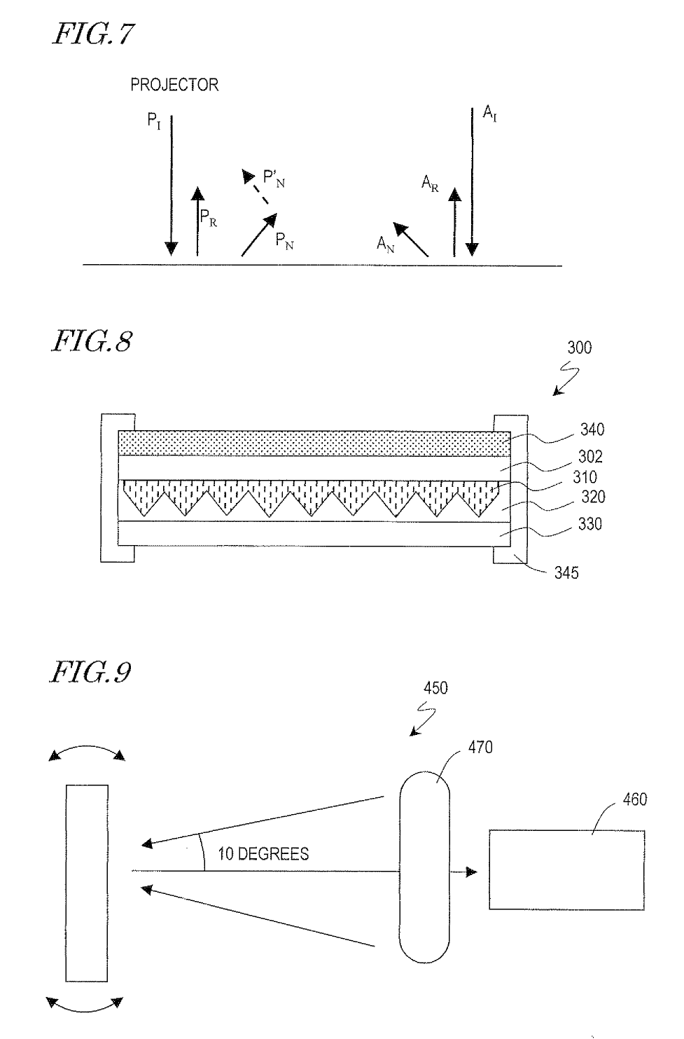

Hereinafter, it will be described with reference to FIG. 7 what retro-reflected and non-retro-reflected components of the projected light and ambient light are produced by the screen of this embodiment and the counterparts of Comparative Examples 1 and 2. In FIG. 7, P_{I} denotes the entire projected light directed from a projector toward the screen, P_{R} denotes the retro-reflected component of P_{I}, and P_{N} denotes the non-retro-reflected component of P₁. Also, A_{I} denotes the ambient light directed toward the screen, A_{R} denotes the retro-reflected component of A_{I}, and A_{N} denotes the non-retro-reflected component of A_{I}.

Herein, to avoid complicating the description excessively, the non-retro-reflected component A_{N} of the ambient light is supposed to reach the viewer in the dark display mode. Also, the non-retro-reflected component A_{N} of the ambient light, the retro-reflected component P_{R} of the projected light, and part of the non-retro-reflected component P_{N} of the projected light (as already described with reference to FIG. 5) are supposed to reach the viewer in the bright display mode.

In this case, the contrast ratio CR of the screen is represented by

CR=(P_{R}+A_{N}+P′_{N})/A_{N}

where P′_{N} denotes that part of the non-retro-reflected component P_{N} of the projected light that reaches the viewer. The more intense the projected light, the greater the percentage of that component. In that case, such a component will produce noise in the resultant image just like the non-retro-reflected component A_{N}. Also, the greater the percentage of the non-retro-reflected component P_{N} of the projected light, the greater the percentage of non-display light component that reaches the viewer just like the non-retro-reflected component A_{N} of the ambient light.

First of all, the screen of Comparative Example 1 will be described. As the screen of Comparative Example 1 reflects diffusively the incident light, the percentages of the retro-reflected components P_{R} and A_{R} produced will be relatively low but those of the non-retro-reflected components P_{N} and A_{N} produced will be relatively high. That is why the screen of Comparative Example 1 has a low contrast ratio.

On the other hand, as the screen 200 of Comparative Example 2 retro-reflects the incident light, the percentages of the retro-reflected components P_{R} and A_{R} produced will be relatively high and those of the non-retro-reflected components P_{N} and A_{N} produced will be relatively low. Consequently, the screen 200 of Comparative Example 2 has a higher contrast ratio than the counterpart of Comparative Example 1.

Meanwhile, since the screen 100 of this embodiment has a light absorbing layer 130, the percentages of the non-retro-reflected components P_{N} and A_{N} produced will be lower than in the screen 200 of Comparative Example 2. As a result, the screen 100 has a higher contrast ratio than the screen 200 of Comparative Example 2.

Hereinafter, the optical property of the screen 100 of this embodiment will be further described in comparison with a screen representing Comparative Example 3. First of all, the screen of Comparative Example 3 will be described.

FIG. 8 is a schematic representation illustrating the screen 300 as Comparative Example 3. Unlike the screen of this embodiment, the screen 300 of Comparative Example 3 includes a light diffusing layer 330 in place of the light absorbing layer. The light diffusing layer 330 may be a sheet of white paper, for example, of which the reflectance is approximately 80% with respect to that of the perfect diffuser. Also, just like the screen 100 described above, the screen 300 includes an AGAR film with a haze value of 7% as the light scattering layer 340. It should be noted that the light scattering layer 340, the base member 302 and the retroreflective layer 310 are all transparent and will sometimes be collectively referred to herein as a “transparent member 360”.

Hereinafter, the optical property of the screen 100 of this embodiment will be compared to that of the screen 300 of Comparative Example 3.

FIG. 9 is a schematic representation illustrating a measuring system 450 for evaluating the optical properties of the screens 100 and 300. The measuring system 450 includes a ring fluorescent lamp 460 and a luminometer 470, which are arranged at a distance of 39 cm in front of the screen. The ring fluorescent lamp 460 is a ringlike fluorescent lamp with an outside diameter of 8 cm and an inside diameter of 6.8 cm and is used instead of a projector. The fluorescent lamp 460 has a ring shape and the angle defined between a line that connects together the luminometer 470 and the screen and a line that connects together the ring fluorescent lamp 460 and the screen is approximately 10 degrees. Also, the ambient surrounding the screen is relatively bright and has an ambient illuminance of approximately 2,000 lx.

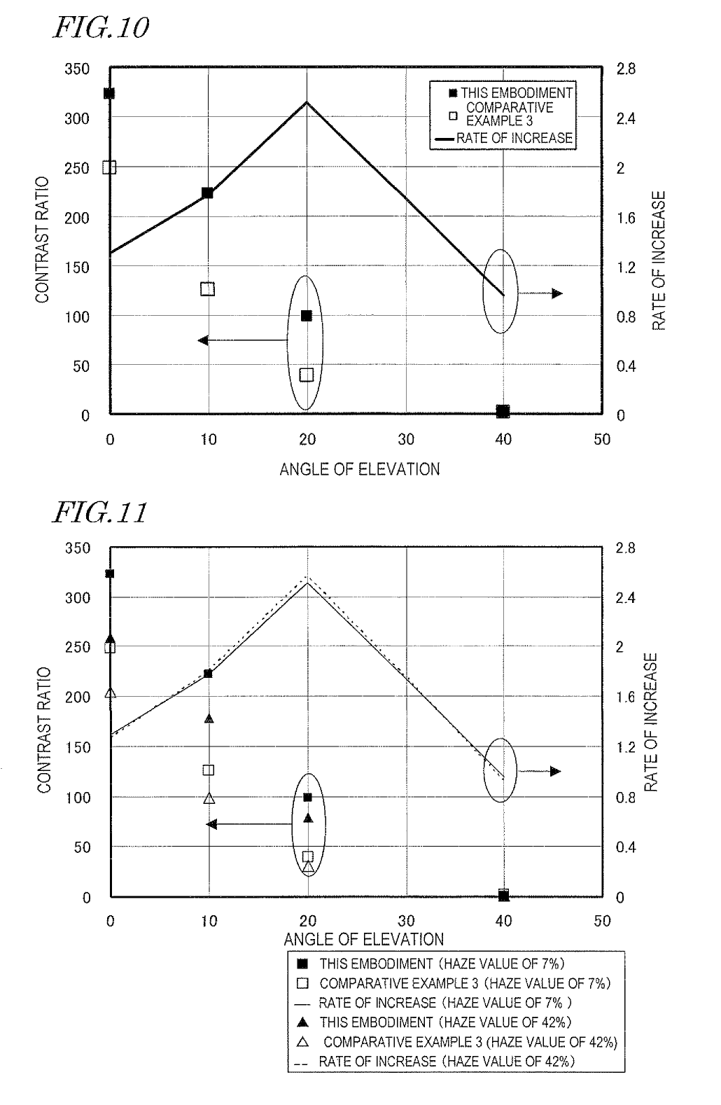

FIG. 10 is a graph showing the optical properties of the screen 100 of this embodiment and the screen 300 of Comparative Example 3. In the graph shown in FIG. 10, the ordinates on the left-hand side represent the contrast ratios that were measured using a luminometer with the angle of elevation of the screen changed in the order of 0, 10, 20 and 40 degrees and with the ring fluorescent lamp turned ON and OFF. As used herein, the “angle of elevation” refers to the angle defined by the screen with respect to a plane that intersects with the optical axis of the projector at right angles, the optical axis being substantially parallel to the viewing direction of the viewer. That is to say, the greater the angle of elevation, the steeper the angle at which the viewer is viewing the screen. Also, the contrast ratio is obtained by dividing the luminance of the ring fluorescent lamp in ON state by that of the same lamp in OFF state. On the other hand, in the graph shown in FIG. 10, the ordinate on the right-hand side represent the ratio of the contrast ratio of the screen 100 to that of the screen 300. That is to say, this value represents the rate of increase in contrast ratio to be achieved by using the light absorbing layer 130 instead of the light diffusing layer 330.

As can be seen from FIG. 10, the contrast ratio of the screen 100 is higher than that of the screen 300 if the angle of elevation falls within the range of 0 to 20 degrees. For example, if the angle of elevation is 20 degrees, a rate of increase of about 2.5 can be achieved. Thus, by providing the light absorbing layer 130 for the screen 100, a high contrast ratio is realized.

Hereinafter, the difference between the screen 100 of this embodiment and the screen 300 of Comparative Example 3 will be described with reference to FIGS. 6 and 12.

As shown in FIG. 12, in the screen 300 of Comparative Example 3, part of the obliquely incoming light component is transmitted through the transparent member 360 as in the screen 100 that has already been described with reference to FIG. 6. In FIG. 12, the light L3 represents the obliquely incoming light component, the light La represents a refracted light ray, and the light Lo represents a light ray that has been transmitted through the transparent member 360.

The light ray Lo is reflected diffusively from the light diffusing layer 330, incident on the transparent member 360 again, transmitted through the transparent member 360, and then directed toward the front side. As a result, the non-retro-reflected component will reach the viewer and the screen 300 does not look dark in the dark display mode.

Also, in the screen 300 of Comparative Example 3, the larger the angle of elevation, the smaller the ratio of the retro-reflected component of the projected light to the non-retro-reflected component of the ambient light and the more significantly the contrast ratio tends to decrease as a result.

On the other hand, in the screen 100 of this embodiment, part of the non-retro-reflected component (such as the light ray Lm) passes through the retroreflective surface. But as the light absorbing layer 130 is arranged so as to face the rear side 114 of the retroreflective layer 110, the light ray Lm gets absorbed into the light absorbing layer 130 as already described with reference to FIG. 6. As a result, the percentage of the non-retro-reflected component that reaches the viewer can be reduced and the screen 100 looks reasonably dark in the dark display mode. In addition, as the ratio of the retro-reflected component of the projected light to the non-retro-reflected component of the ambient light decreases relatively gently even if the angle of elevation increases, the decrease in contrast ratio is much less significant.

As described above, in the screen 300 of Comparative Example 3, the non-retro-reflected component that has been transmitted through the transparent member 360 is reflected diffusively from the light diffusing layer 330 and is eventually reflected back toward the front side. And part of that reflected light will reach the viewer. Particularly if the non-retro-reflected component of the ambient light reached the viewer in the dark display mode, the screen 300 would look bright and a sufficiently high contrast ratio could not be achieved as a result. On the other hand, in the screen 100 of this embodiment, even the non-retro-reflected component that has been transmitted through the transparent member 160 will get absorbed into the light absorbing layer 130, and therefore, the percentage of the non-retro-reflected component that reaches the viewer can be reduced. Among other things, as the screen 100 of this embodiment can prevent the non-retro-reflected component of the ambient light from reaching the viewer in the dark display mode, a high contrast ratio can be achieved.

Hereinafter, it will be described with reference to FIG. 7 again what retro-reflected and non-retro-reflected components of the projected light and ambient light are produced by the screen 100 of this embodiment and the screen 300 of Comparative Example 3.

In the screen 300 of Comparative Example 3, the light that has been transmitted through the interface between the retroreflective layer 310 and the air layer 320 is reflected diffusively from the light diffusing layer 330, and therefore, the percentages of the non-retro-reflected components P_{N} and A_{N} are relatively high. On the other hand, since the screen 100 of this embodiment includes the light absorbing layer 130, the percentages of the non-retro-reflected components P_{N} and A_{N} can be reduced compared to the screen 300 of Comparative Example 3. Consequently, the screen 100 can achieve a higher contrast ratio than the screen 300 of Comparative Example 3 by reducing the non-retro-reflected component A_{N}.

Also, the larger the angle of elevation, the steeper the angle defined by the projected light P_{I} that is going to incident obliquely onto the screen with respect to the screen. As a result, the percentage of the non-retro-reflected component P_{N} increases and that of the retro-reflected component P_{R} decreases. That is why as the angle of elevation increases, the contrast ratios of the screens 100 and 300 decrease. Among other things, in the screen 300 of Comparative Example 3, the ratio of the retro-reflected component of the projected light to the non-retro-reflected component of the ambient light decreases particularly significantly, and therefore, the contrast ratio decreases considerably.

Hereinafter, the rate of increase will be described. The rate of increase is represented by

((P_{Ra}+A_{Na}+P′_{Na})/A_{Na})/((P_{Rb}+A_{Nb}+P′_{Nb})/A_{Nb})

where P_{Ra} denotes the retro-reflected component of the projected light in the screen 100 of this embodiment, A_{Na} denotes the non-retro-reflected component of the ambient light in the screen 100, and P′_{Na} denotes part of the non-retro-reflected component of the projected light that reaches the viewer in the screen 100. In the same way, P_{Rb} denotes the retro-reflected component of the projected light in the screen 300 of Comparative Example 3, A_{Nb} denotes the non-retro-reflected component of the ambient light in the screen 300, and P′_{Nb} denotes part of the non-retro-reflected component of the projected light that reaches the viewer in the screen 300.

If the angle of elevation is zero degrees, the optical axis of the projector crosses the screen at right angles. That is why the percentage of the retro-reflected component P_{Ra}, P_{Rb} of the projected light is high but that of the non-retro-reflected component P′_{Na}, P′_{Nb} of the projected light is low. Meanwhile, the percentage of the non-retro-reflected component A_{Na}, A_{Nb} of the ambient light is not so high, and therefore, the retro-reflected components P_{Ra} and P_{Rb} of the projected light are equal to each other, theoretically speaking. Consequently, the rate of increase is rather close to one.

On the other hand, if the angle of elevation falls within the range of approximately 10-20 degrees, then the projected light will be incident obliquely onto the screen. That is why compared to the situation where the projected light is incident perpendicularly onto the screen, the percentages of the retro-reflected components P_{Ra} and P_{Rb} of the projected light decrease and the non-retro-reflected components P′_{Na} and P′_{Nb} of the projected light increase instead. As a result, as the difference between the non-retro-reflected components A_{Na}, P′_{Na} and A_{Nb}, P′_{Nb} becomes more influential. Consequently, the larger the angle of elevation, the higher the rate of increase.

Furthermore, once the angle of elevation exceeds 20 degrees, the light will be incident onto the retroreflective surface at a smaller angle than the critical angle. That is why the incident light is not totally reflected but the percentage of the incident light transmitted through the retroreflective surface and directed toward the rear side increases steeply. As a result, the percentage of the retro-reflected component P_{Ra}, P_{Rb} decreases and the influence of the non-retro-reflected component A_{Na}, A_{Nb}, increases instead. Consequently, if the angle of elevation becomes too large, the rate of increase will decrease all the way down to almost one.

The results shown in the graph of FIG. 10 were obtained by using an AGAR film with a haze value of 7% as the light scattering layer. However, the present invention is in no way limited to it. If necessary, an even greater degree of scattering could be caused by the light scattering layer.

FIG. 11 is a graph showing the results that were obtained by using a light scattering layer with a haze value of 42% as the light scattering layer 140, 340. The graph of FIG. 11 also shows the results of FIG. 10 for your reference.

As the light scattering layer 140, 340 has a larger haze value, the contrast ratio decreases to some extent. Even so, the screen 100 still has a higher contrast ratio than the screen 300 when the angle of elevation falls within the range of 0-20 degrees. On top of that, even though light scattering layers with different haze values are used, the rate of increase of the contrast ratio varies in very similar patterns according to the angle of elevation. Specifically, if the angle of elevation is 20 degrees, a rate of increase of approximately 2.5 can be achieved.

As shown in FIGS. 10 and 11, when the measuring system 450 shown in FIG. 9 is used, the rate of increase of the contrast ratio in a situation where the screen 100 or 300 is viewed straight is approximately 1.3, which is sufficiently high. Nevertheless, in a situation where the rate of increase is estimated subjectively with the naked eye, if the absolute value of the contrast ratio is large (e.g., 200 or more), then the sensitivity of the viewer could get saturated and the viewer could sometimes sense no increase in contrast ratio anymore.

Also, according to such a subjective estimation with the naked eye, if the viewer views the screen from a viewing angle corresponding to an angle of elevation of 10-20 degrees, he or she will sense a significant difference in contrast ratio. However, if the viewer views the screen from a greater viewing angle corresponding to an angle of elevation of 40 degrees, both of the screens 100 and 300 come to have a lower contrast ratio and the viewer can no longer see a good image.

As can be seen, if the viewer is viewing the screen 100 from a position in the vicinity of the front of the screen, e.g., at a polar angle of approximately 0-20 degrees with respect to the screen front, the luminance in the dark display mode can be reduced by providing the light absorbing layer 130. As a result, a display operation can be carried out at a high contrast ratio even under a bright environment.

It should be noted that in a situation where an image including characters needs to be presented on the screen 100, if the pitch of corner cubes were much greater than the front size of those characters, then the characters could not be seen clearly. That is why to display characters clearly, the corner cubes preferably have a pitch of 40 μm or less. For example, if an image with an SVGA resolution (of 800×600 pixels) is projected onto a screen, of which the size is as large as an A4 sheet of paper, then each of those pixels will have a size of approximately 125 μm×375 μm. In that case, the pitch of corner cubes should be smaller than that pixel size. For example, if the pitch of corner cubes is defined to be approximately one third of the pixel size, then the corner cubes should be arranged at a pitch of 40 μm.

Also, the light absorbing layer 130 preferably has a reflectance of 20% or less, more preferably 10% or less. The light absorbing layer 130 may be a commercial available sheet of inkjet printing paper that has been turned into solid black, for example.

In the above description, the low-refractive-index layer 120 is supposed to be an air layer. However, the present invention is in no way limited to it.

Also, in the above description, each of the corner cubes arranged on the rear side 114 of the retroreflective layer 110 has a regular hexagonal shape when viewed from over it. However, the present invention is in no way limited to it. Each corner cube may have an equilateral triangular shape. FIG. 13(a) is a perspective view illustrating the shape of an array of such equilateral triangular corner cubes and FIG. 13(b) is a plan view thereof.

Also, if the retroreflective layer 110 is formed by the 2P process, the base member 102 is preferably thicker than the retroreflective layer 110. Generally speaking, an acrylic material will sometimes shrink when cured. However, if the base member 102 is sufficiently thick, then such shrinkage of the acrylic material can be minimized.

Furthermore, the array of corner cubes arranged on the rear side 114 of the retroreflective layer 110 does not necessarily have an ideal shape but could have a shape that is slightly different from the ideal one. Optionally, as disclosed in Japanese Patent Application Laid-Open Publications No. 5-150368 and No. 2002-250896, the shape of the array of corner cubes could be intentionally modified from the ideal one. The entire disclosures of Japanese Patent Application Laid-Open Publications No. 5-150368 and No. 2002-250896 are hereby incorporated by reference.

Also, if a scattering film with a haze value of 50% is used as the light scattering layer 140, the contrast ratio will decrease significantly. This is because even if the light is retro-reflected from a retroreflective surface but if the light is scattered too much by the light scattering layer 140, the retroreflectivity of the screen 100 would decrease. As can be seen, the haze value of the light scattering layer 140 should not be too large and is preferably less than 50%, for example.

Optionally, a polymer-dispersed liquid crystal (PDLC) layer may be used as the light scattering layer 140.

Furthermore, in the above description, the light scattering member 140 is supposed to have a layered shape. However, the present invention is in no way limited to it. The light scattering member 140 could also have a particle shape or could even be dispersed in the retroreflective layer 110.

Furthermore, in the above description, the screen 100 is supposed to have the light scattering member 140. However, this is just an example of the present invention. If necessary, the screen 100 could have no light scattering members 140, too. Nevertheless, if there is no light scattering member 140 and if the corner cubes are arranged at a constant pitch, then a rainbow pattern could be sensed due to interference. For that reason, it is preferred that the light scattering layer 140 be provided anyway.

### Embodiment 2

Hereinafter, an embodiment of a projection system according to the present invention will be described.

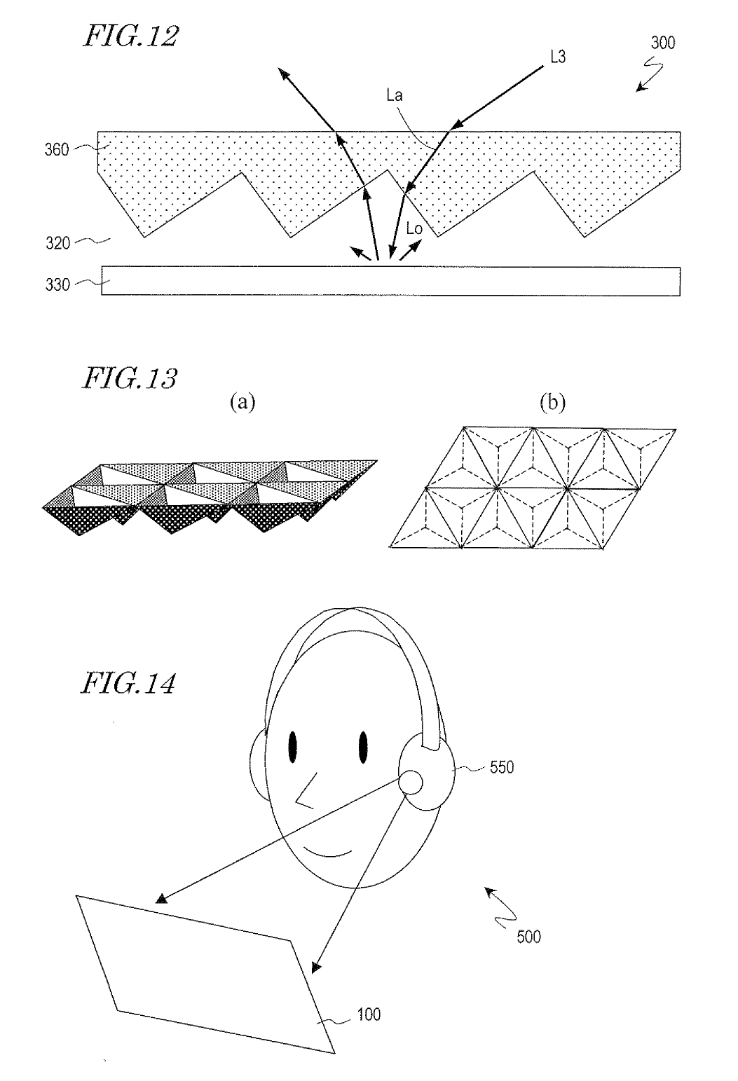

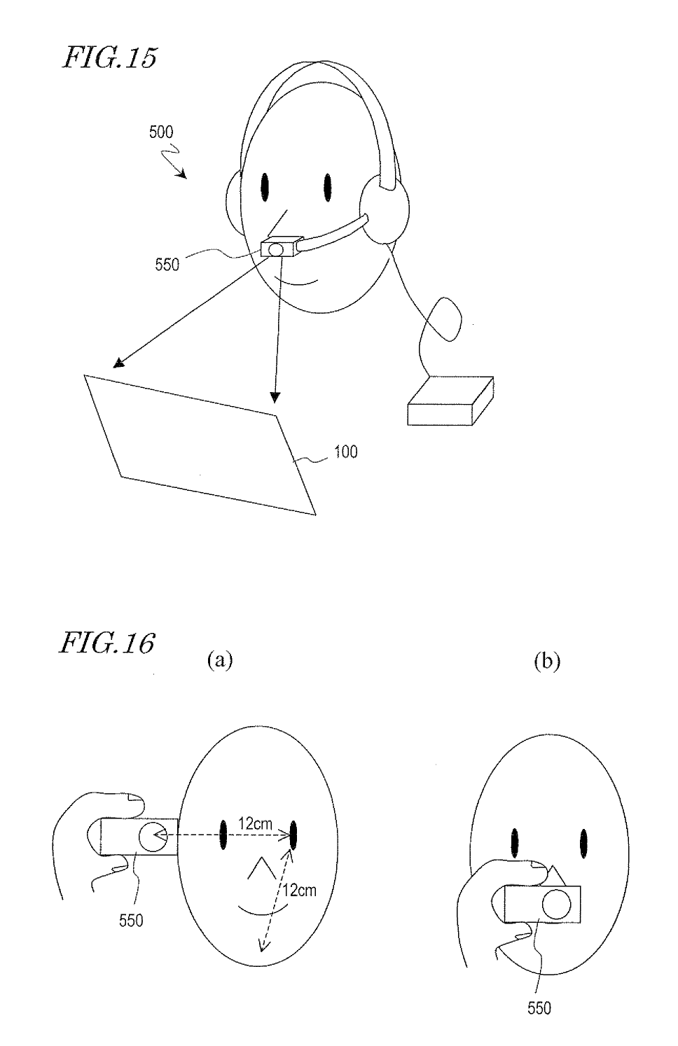

FIG. 14 is a schematic representation illustrating a projection system 500 of the present embodiment. The projection system 500 includes the screen 100 described above and a projector 550 for projecting an image onto the screen 100. The projector 550 is a front projection type projector that projects light onto the front side (i.e., the viewer side) of the screen 100.

In this embodiment, the projection system 500 is supposed to be used for very few people (e.g., only one person). The projector 550 is a portable projector and has its output defined to be too low to cause any problem even if the light emitted from the projector 550 happened to enter the viewer's eyes or a surrounding person's eyes. For example, the projector 550 may have an output of about 10 lm. Currently, a small-sized projector with as low an output as about 10 lm normally has a length of about 5 cm, a width of about 3 cm and a thickness of about 1 cm except its battery. Such a small projector can be arranged with a lot of flexibility.

In a situation where the projector has such a low output, if the screen 100 has too large a size, then sufficient brightness cannot be achieved. Also, if the ambient is bright and if the screen 100 has a big size, then the screen will look excessively bright due to the ambient light and therefore cannot display an image at a high contrast ratio. That is why to achieve a certain degree of brightness in a situation where a projector with a low output is used under a bright environment, the screen 100 is preferably at most as large as an A4 sheet of paper (i.e., a TV screen with a diagonal size of 14 inches). Furthermore, if the screen 100 has such a small size, then the screen 100 can be used not only as a fixed one but also as a hand-held one. Thus, the screen 100 may be held by the viewer.

In the example illustrated in FIG. 14, the projector 550 is built in one of the ear pads of headphones. That is to say, these headphones are designed so that when the viewer wears these headphones, the projection hole of the projector 550 is located beside the head (or an eye) of the viewer. The screen 100 retro-reflects the incident light as described above. That is why the closer to the viewer's eye the projection hole of the projector 550 is located, the better.

It should be noted that the projection system 500 of this embodiment does not have to have such an arrangement. The projector 550 may also be built in a microphone portion of headphones with a microphone (i.e., a headset) and may be connected to one of the ear pads of the headphones with a fiber optic cable as shown in FIG. 15. In that case, a light source is embedded in that ear pad and the light emitted from the light source propagates through the fiber optic cable, reaches the projector 550 and then gets projected toward the screen 100. In this example, in order to lighten the load on the head of the viewer, a battery and other heavy parts are separately assembled in a different package from the headphones. For example, that battery could be pendent around the neck of the viewer or put in his or her bag using a long cable. Also, the projector 550 is arranged so that there are almost equal distances between the projection hole of the projector 550 and the right and left eyes of the viewer.

It should be noted that if there were different distances between the projector 550 and the right and left eyes of the viewer as shown in FIG. 14, then the viewer would view image components with mutually different brightness values with his or her eyes. That is why if he or she continued to view such an image for a long time, he or she would feel uncomfortable and might get tired easily. To avoid such a situation, by arranging the projector 550 right in front of the viewer's face (e.g., in front of his or her mouth) as shown in FIG. 15, there will be almost equal distances between the projector 550 and the viewer's eyes, and therefore, he or she would feel much less uncomfortable.

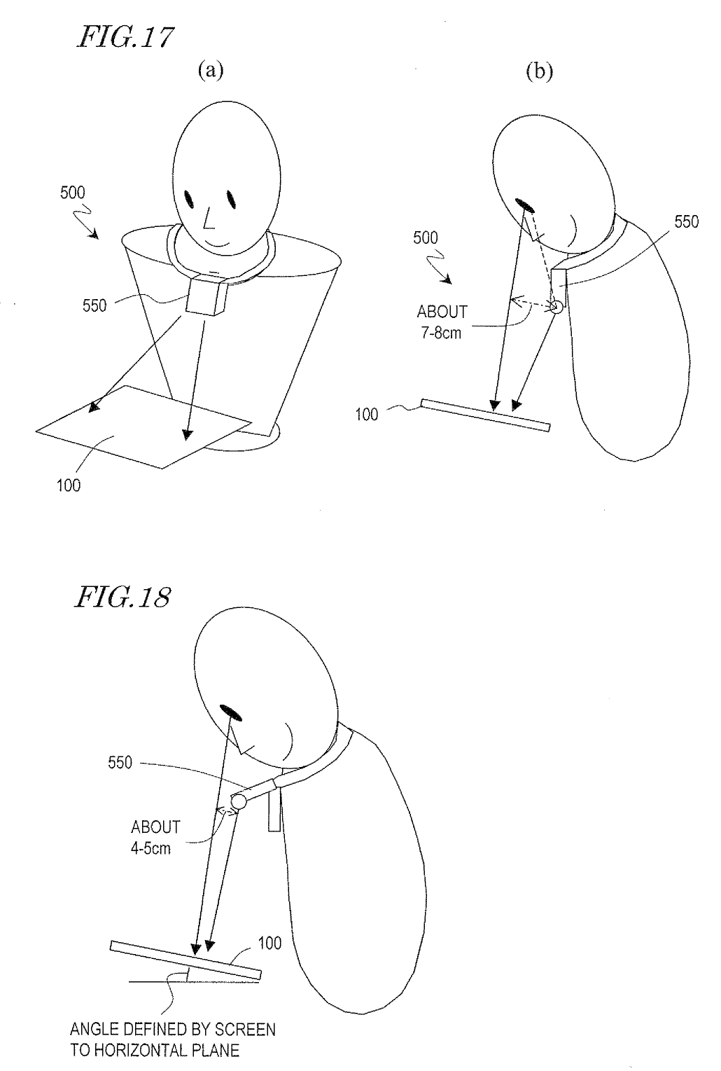

Hereinafter, specific arrangements of the projector will be described with reference to FIGS. 16(a) and 16(b). If the projector 550 is arranged beside the right-hand side of the viewer's head as shown in FIG. 16(a), the distance from the projection hole of the projector 550 to the right eye of a general adult will be around 6 cm while the distance from the projection hole of the projector 550 to his or her left eye will be around 12 cm. If the distance from the projector 550 to an eye exceeded 12 cm, then the image component to be sensed with that eye would be rather dark. For that reason, in the arrangement shown in FIG. 14, the distance is preferably equal to or shorter than 12 cm.

Also, there is a distance of approximately 12 cm between an eye and the jaw of a general adult. That is why if the projection hole of the projector is arranged in front of the viewer's mouth, then the distance from a viewer's eye to the projection hole of the projector will be equal to or less than 12 cm as shown in FIG. 16(b). As a result, with the arrangement shown in FIG. 15, the viewer can view a bright image.

The results of the subjective evaluation of images displayed at multiple different locations and with different ambient illuminances using this projection system 500, will be described below. In the projection system 500, as the projector 550, a projector LVP-PK20 produced by Mitsubishi Electric Corporation, to which a beam attenuator filter was attached so that the projector would have an emitting luminous flux of 10 lm so as to be used appropriately in mobile electronic devices, was used together with the above described screen 100. The projector LVP-PK20 had a width of 12 cm, a depth of 10 cm and a thickness of 5 cm.

More specifically, the subjective evaluation was carried out indoors beside a window at 2 pm on one fine day in May in Tenri, Nara, Japan (which is located at lat. 34N and long. 135E) with the projector LPV-PN20 arranged near a viewer's eyes as shown in FIG. 16. The results are summarized in the following Table 2:

TABLE 2
Indoors beside a window (fine day)

| Ambient illuminance | How the image looked |
|---|---|
| Up to 5,000 lx | Clear |
| 5,000 lx to 10,000 lx | Fine |
| 10,000 lx to 25,000 lx | Barely viewable |
| 25,000 lx to 40,000 lx | Non-viewable |
| 35,000 lx (with the sun right | Non-viewable |
| over the head) | |

On the other hand, the results of a subjective evaluation that was carried out outdoors are summarized in the following Table 3:

TABLE 3
Outdoors

| Ambient illuminance | How the image looked |
|---|---|
| 12,000 lx | Barely viewable |
| 18,000 lx | Non-viewable |

The Table 4 shows the results of subjective evaluation in a car, which was directed to the east with direct sunlight coming in through the window beside the driver's seat.

TABLE 4

| | | How the image |
|---|---|---|
| Ambient illuminance | Location | looked |
| 22,000 lx | In front of car | Barely viewable |
| | navigator | |
| 2,200 lx | Behind sun visor | Clear |

As can be seen from the results shown in Tables 2 to 4, when the ambient illuminance was equal to or smaller than 5,000 lx, a clear image was viewable. That is why in a normal room where the ambient illuminance is less than 5,000 lx, a clear image is viewable. Also, even outdoors, the image was at least viewable except in direct sunlight.

A lot of people would take it for granted that a conventional projector can be used only under a dark environment. However, if the screen of this embodiment is used and if a projector is arranged near the viewer's eye, the projector can also be used even in a bright environment. As a result, the projector can be used in a much broader range.

As described above, with this screen 100, even if the projector 550 with as low an output as approximately 10 lm is used under a bright environment, the viewer can also view a bright and clear image at a high contrast ratio.

In the above description, the projector is supposed to be either built in the headphone to be worn by the viewer or directly held with the viewer's hand. However, the present invention is in no way limited to it. The projector could be supported in a different way by the viewer.

For example, as shown in FIG. 17(a), the projector 550 may be tied up with a string, which the viewer may wear around his or her neck while using the projector 550. When the viewer wears the string, the projector 550 is located at his or her collar. In that case, the projection hole of the projector 550 faces down and the light is projected in the direction in which the viewer looks down. If the viewer arranges the screen 100 at his or her loins, the light is projected from the projector 550 toward the screen 100. Supposing the distance from the viewer to the screen 100 is 20 cm and distance from the projector 550 to the screen 100 is 12 cm, for example, the appropriate range of the angle defined by the line that connects together the viewer and the screen 100 with respect to the line that connects together the projector 550 and the screen 100 is equal to or less 30 degrees.

In that case, the direct distance from the viewer's eyes to the projector is longer than 12 cm. However, when projected onto the screen 100, the line segment that connects together the viewer's eyes and the projector 550 has a length that is shorter than 12 cm (and that corresponds to the distance from the line segment that connects together the viewer's eyes and the screen 100 to the projector 550) as shown in FIG. 17(b). The length may be 7-8 cm, for example. Consequently, the projection of the line segment that connects the viewer's eyes and the projector 550 onto the screen 100 can also be shortened and a decrease in the brightness of the image can be suppressed. Also, in that case, the light is projected basically downward from the projector 550, and therefore, it is possible to prevent the light from happening to strike other people's eyes.

Optionally, the projector 550 could be built in a clamshell (foldable) cellphone. Or the projector 550 itself may have a similar structure to such a clamshell (foldable) cellphone.

FIG. 18 is a schematic representation illustrating a foldable cellphone with a built-in projector 550. In such a situation where the projector 550 is built in a foldable cellphone, if the projection hole of the projector 550 is arranged at the end of the cellphone opened, then the line segment that connects together the viewer's eyes and the projector 550 will have a length of approximately 4-5 cm when projected onto the screen 100. Also, in that case, even if the angle defined by the screen with respect to a horizontal plane is increased, that length will still be approximately 7-8 cm as shown in FIG. 19. That is why the angle at which the viewer is looking down may be relatively small, and therefore, his or her fatigue can be lessened.

Furthermore, if the projector is built in such a foldable cellphone and projects light when the cellphone is opened as shown in FIG. 18, the line segment that connects together the viewer's eyes and the projector 550 will have an even shorter length when projected onto the screen 100. With the length further shortened, even if the screen is rather uplifted as shown in FIG. 19, a bright display can still be maintained and the screen can be arranged more flexibly.

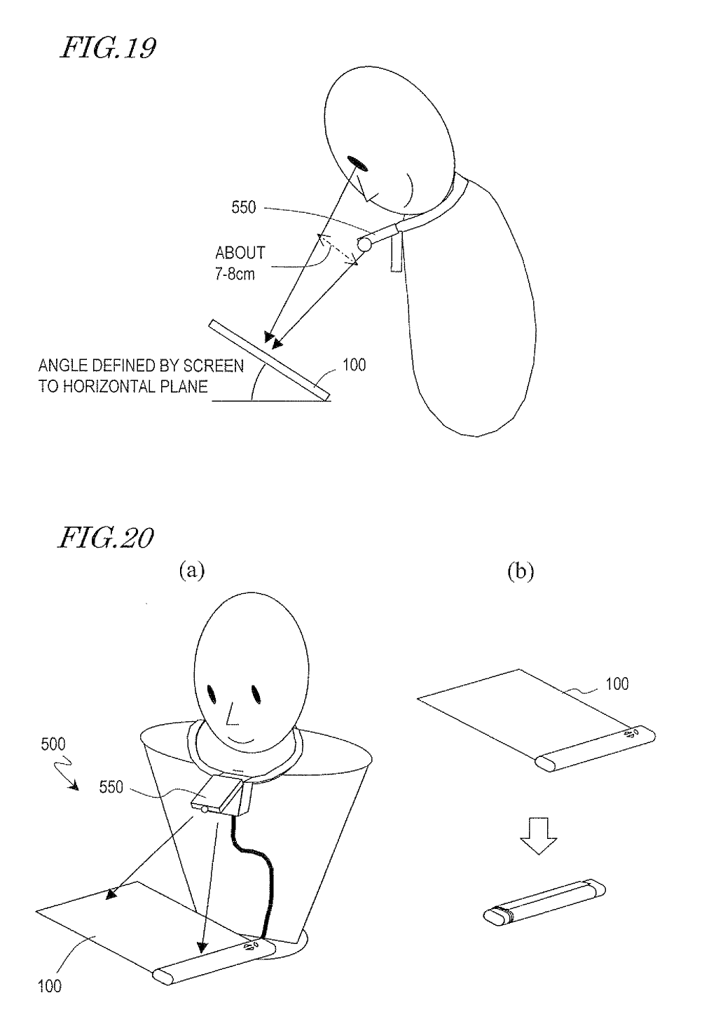

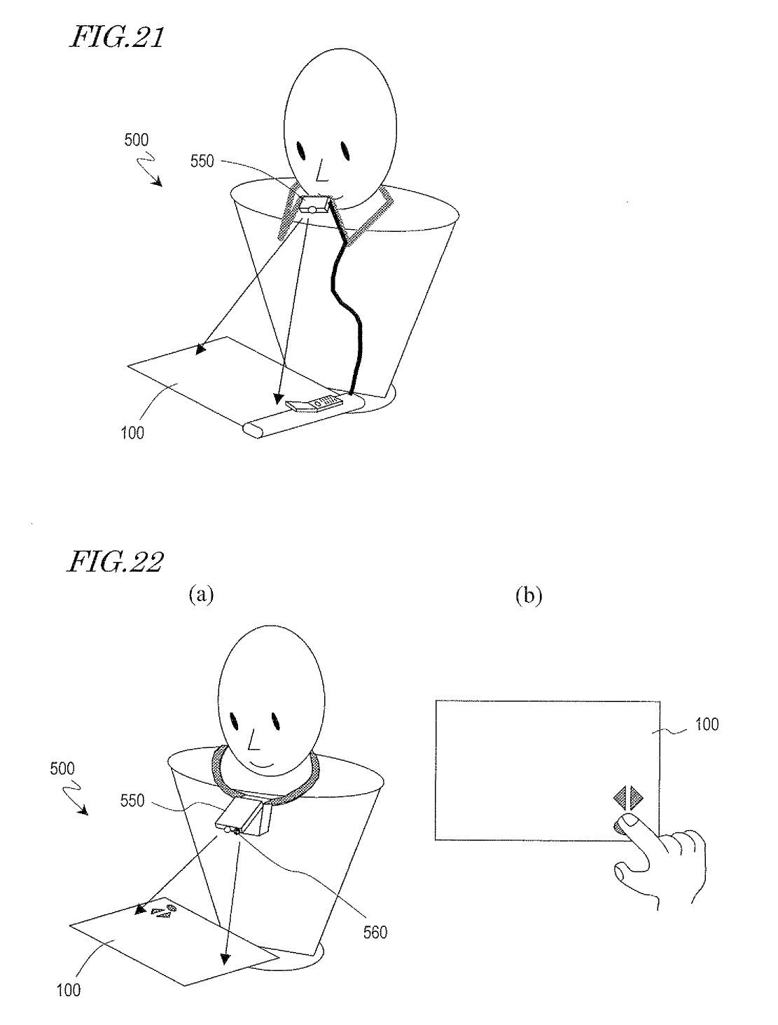

Alternatively, the screen 100 could be integrally arranged with a jacket as shown in FIG. 20(a). A battery to drive the cellphone is built in that jacket and power is supplied to the cellphone through a power supply cable that is connected to the jacket. Also, on the surface of that jacket, arranged are remote controller buttons to allow the viewer to control the image to be produced by the projector 550. The commands entered by the viewer are conveyed to the projector 550 through the power supply cable. It should be noted that the display data to be projected by the projector 550 is stored in the cellphone. Optionally, when not used, the screen 100 could be rolled up and stored as shown in FIG. 20(b). In that case, the screen 100 is portable more easily.

Still alternatively, the projector 550 could also be attached to a holder that has a similar shape to a so-called “harmonica holder” as shown in FIG. 21. If the viewer wears that holder around his or her neck, the projector 550 will be located right in front of his or her mouth. The projector 550 has a rectangular parallelepiped shape, of which the length, width and height have a ratio of three to one to one. Also, a cellphone fixing stage is arranged on the jacket on which the screen 100 is rolled up. This cellphone has a control function, a character entering function, and a memory function. In this example, the jacket is also connected to the projector through a cable and power is supplied, and the projector is controlled, through the cable.

In the above description, the user interface section is supposed to be arranged on the jacket on which the screen is rolled up. However, the present invention is in no way limited to it.

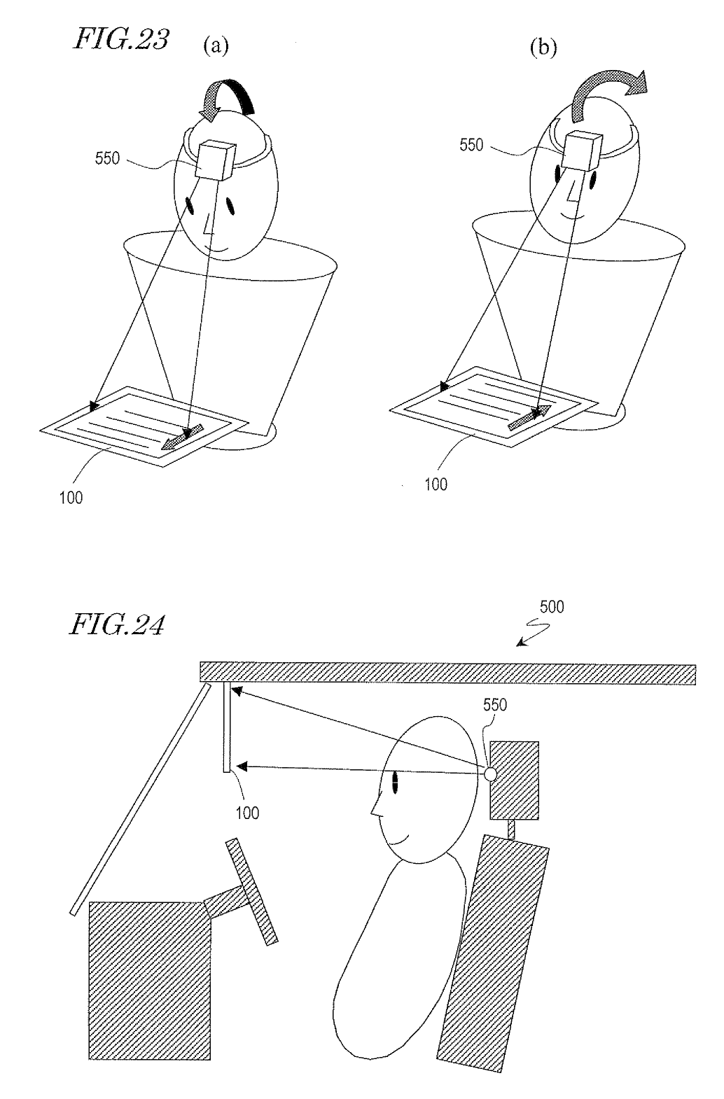

The cellphone with the built-in projector 550 may have a photodetector 560 as shown in FIG. 22(a). In this case, the projector 550 projects not only a normal image but also an image of control buttons onto the screen 100. Those control buttons are virtual ones that are displayed on the screen 100 as shown in FIG. 22(b). If the viewer presses one of those buttons, then the light that is retro-reflected from the screen 100 to reach the photodetector 560 will be cut off. And if the photodetector 560 senses that, an appropriate operation will be performed on the projector 550 in accordance with the command that has been entered with the control button. In this manner, the projector 550 may be operated with such virtual buttons.

Still alternatively, the projector 550 may be integrally arranged with an acceleration sensor as shown in FIG. 23. The projector 550 is tied up with a string. And when the viewer wears the string around his or her head, the projector 550 will be located right in front of his or her forehead. In that case, if the viewer shakes his or her head forward, the screen image will scroll up as shown in FIG. 23(a). Conversely, if the viewer shakes his or her head backward, then the screen image will scroll down as shown in FIG. 23(b). As a result, the viewer can change the screen images produced by the projection system 500 even without operating with his or her hands at all.

In the above description, the viewer is supposed to support the projector 550. However, the present invention is in no way limited to it. Also, in the above description, the viewer is supposed to hold the screen 100. However, the present invention is in no way limited to it. Also, in the above description, the viewer is supposed to support both the screen 100 and the projector 550. However, the present invention is in no way limited to it. At least one of the screen 100 and the projector 550 could be fixed around the viewer.

For example, as shown in FIG. 24, the projection system 500 may be installed in a passenger car. In the example illustrated in FIG. 24, the projector 550 is arranged on the head rest of a driver's or assistant driver's seat so that the driver of the car can view it. More specifically, the screen 100 is attached to the back surface of a sun visor that is arranged on the ceiling of the passengers' space. In that case, the projection system 500 may present so-called “car navigation information”. In this manner, the projection system 500 can also be used in a car. Optionally, the projector 550 may also be arranged on the ceiling. As already described with reference to Table 4, the screen 100 can also be viewed even in a car.

Alternatively, as shown in FIG. 25, the projector 550 may also be arranged on the head rest of a viewer's seat and the screen 100 may also be arranged on the rear side of the seat in front of him or her so that the viewer who is not seated in either the driver's seat or the assistant driver's seat (e.g., on the rear seat of the car) or who is seated in an airplane or Shinkansen seat, for example, can view it. Also, as the screen 100 retro-reflects the light that has been emitted from the projector 550, it is possible to prevent a passenger who is viewing a movie in a dark airplane cabin seat from disturbing his or her neighbor with leaking light, for example.

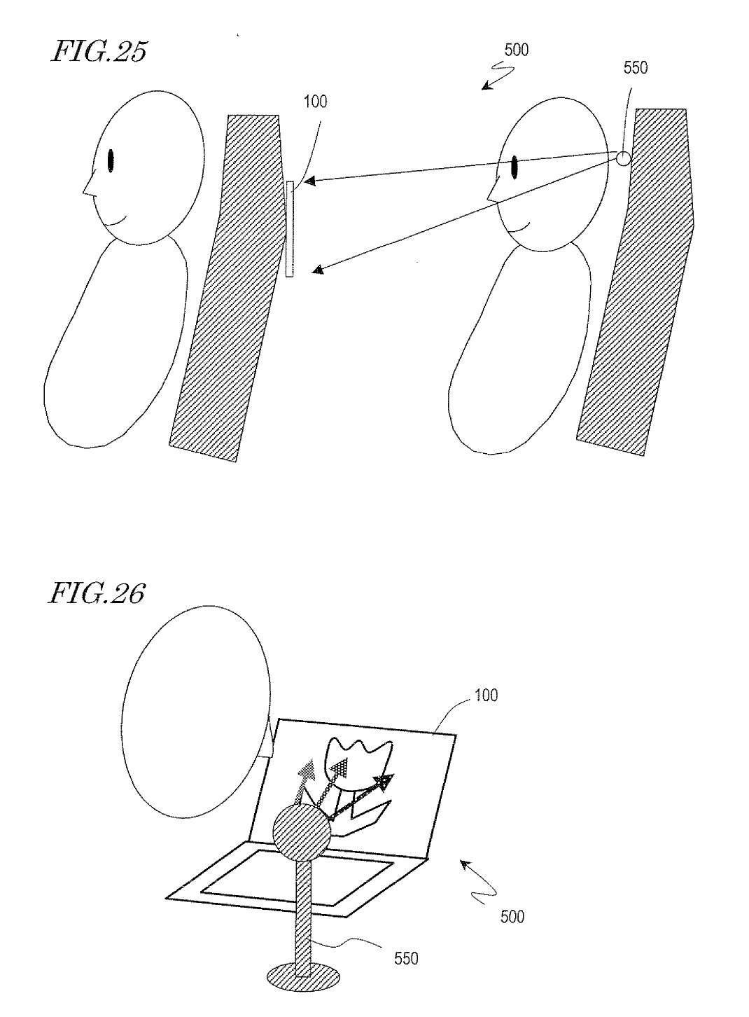

Still alternatively, as shown in FIG. 26, the screen 100 may also be arranged so as to be viewed just like the monitor screen of a laptop (i.e., what they call a “notebook PC” in Japan) and the projector 550 may also be arranged on a flat surface (e.g., on the desk surface) so that its projection hole is located beside the viewer. If the screen 100 is arranged on the back of the front seat or the table, the viewer can view the image even without holding the screen 100.

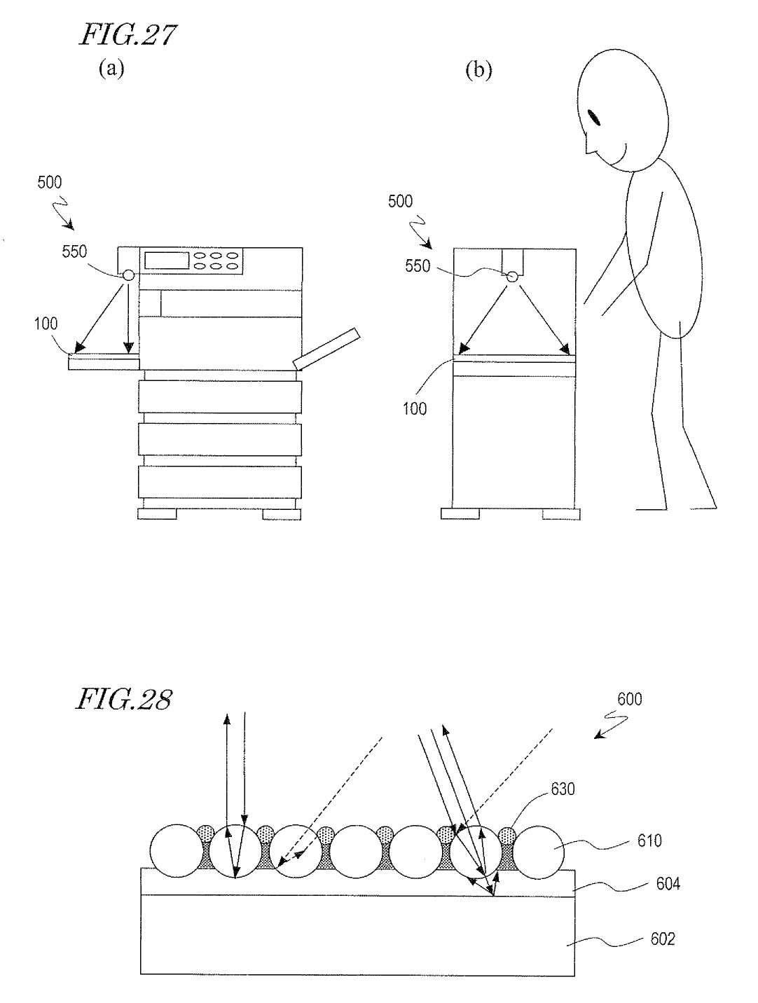

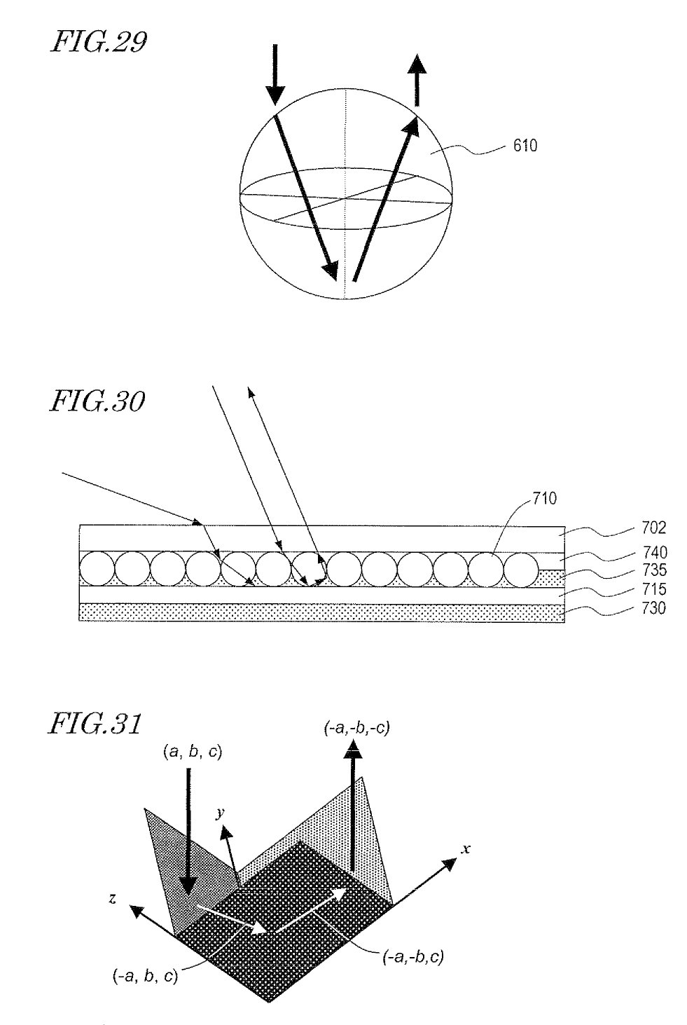

Furthermore, as shown in FIG. 27, the projection system 500 may also be introduced into either a copy machine or a multifunction printer-copier-scanner machine. As shown in FIG. 27, the screen 100 is arranged on the upper surface of the output tray of the copy machine and the projector 550 is arranged so as to face the screen 100. Generally speaking, a copy machine can make a copy of the original in a larger or smaller size but cannot produce a copied image in a viewable form without actually printing it on paper. However, if this projector 550 is used to project an image of the original, of which the size has been either increased or decreased based on its data, onto the screen 100, the projector 550 can produce a copied image even without printing it.

In the foregoing description, the projection system is supposed to be used for very few people, the screen is supposed to have a small size, and the projector is supposed to have a low output. However, the present invention is in no way limited to it. The projection system may also be designed to be used for a lot of people, the screen may have a big size, and the projector may have a high output.

The entire disclosure of Japanese Patent Application No. 2007-247948, on which the present application claims priority, is hereby incorporated by reference.

### INDUSTRIAL APPLICABILITY

By using the screen of the present invention, a display operation can be carried out at a high contrast ratio. In addition, even if a projector with a low output is used under a bright environment, the image displayed is still viewable easily.

1. A screen comprising:
a retroreflective layer, which has a front side and a rear side and which includes an array of corner cubes on the rear side;
a low-refractive-index layer, which is made of a substance with a lower refractive index than the retroreflective layer and which is in contact with at least a portion of the array of corner cubes of the retroreflective layer; and
a light absorbing layer for absorbing at least a part of the light that has been incident on the retroreflective layer on the front side thereof and then directed toward the low-refractive-index layer through the rear side thereof.

2. The screen of claim 1, wherein at least a portion of the light absorbing layer faces the array of corner cubes of the retroreflective layer with the low-refractive-index layer interposed between itself and the retroreflective layer.

3. The screen of claim 1, wherein the low-refractive-index layer is an air layer.

4. The screen of claim 1, further comprising a light scattering member for scattering a part of the light that has been incident on the retroreflective layer on the front side thereof and then retro-reflected from an interface between the rear side of the retroreflective layer and the low-refractive-index layer.

5. The screen of claim 4, wherein the light scattering member includes a light scattering layer.

6. The screen of claim 5, wherein the light scattering layer has a haze value of less than 50%.

7. The screen of claim 4, wherein the light scattering member includes scattering particles that are dispersed in the retroreflective layer.

8. The screen of claim 1, further comprising a fixing member for fixing the retroreflective layer, the light absorbing layer, and the low-refractive-index layer together so that the retroreflective layer faces the light absorbing layer with the low-refractive-index layer interposed between them.

9. A projection system comprising
the screen of claim 1, and
a projector with a projection hole for projecting light toward the screen.

10. The projection system of claim 9, wherein when used, the projector is arranged in substantially the same direction as a viewer who is viewing the screen as viewed from at least some area of the screen.

11. The projection system of claim 10, wherein when projected onto the screen, a line segment, which connects together the viewer's eye and the projector, has a length of less than 12 cm.

12. The projection system of claim 11, wherein when used, the projector has its projection hole arranged near the viewer's eye.

13. The projection system of claim 10, wherein when used, at least one of the projector and the screen is held by the viewer.

14. The projection system of claim 13, wherein when used, the screen is held by the viewer with his or her hands.

15. The projection system of claim 10, wherein when used, at least one of the projector and the screen is arranged around the viewer.
